(19) United States
(12) Patent Application Publication
(10) Pub. No.: US 2023/0034990 A1
(43) Pub. Date: Feb. 2, 2023

(54) DOUBLE-WALLED PREFORM AND METHODE FOR FABRICATING THIS PREFORM

(71) Applicant: DAUNIA PLAST S.P.A., TRINITAPOLI (IT)

(72) Inventor: Mauro DE PASQUALE, TRINITAPOLI (BT) (IT)

(73) Assignee: DAUNIA PLAST S.P.A., TRINITAPOLI (IT)

(21) Appl. No.: 17/758,299

(22) PCT Filed: Dec. 31, 2020
(86) PCT No.: PCT/IB2020/062589

§ 371 Date: Jun. 30, 2022

(30) Foreign Application Priority Data
Dec. 31, 2019 (IT) 102019000025858

(51) Int. Cl. B29B 11/14; B65D 1/02; B65D 23/02; B65D 25/14; B65D 83/00; B29C 49/06

(52) U.S. Cl. CPC B29B 11/14; B65D 1/0215; B65D 23/02; B65D 25/14; B65D 83/0055; B29C 49/06; B29C 2049/024

(57) ABSTRACT

An assembled preform (1) is provided for the making of a blown container, comprising a first external preform body (10) which comprises a neck part (2) which has an external region (4) which includes a threaded region (5) and an internal surface (3), and a second internal preform (11) which is suitable to be completely contained within said first external preform body (10), said second internal preform (11) having a neck region (12) suitable to cooperate with said neck internal surface (3) of said first external preform (10), the preform being characterized in that said neck region (12) of said second internal preform (11) comprises locking means (13,14) integrally obtained on the material of said second preform (11) and suitable for cooperating by blocked interference with said internal region (3) of the neck part (2) of said external preform (10) when said second internal preform (11) is inserted in said first external preform (10).

The present invention relates to a process for the making of a double-walled preform for making double-walled containers following to the blowing of said preform, and more precisely to a process for the making of an assembled preform which consists of two concentric preforms of which an first internal preform is inserted in a fixed manner inside a second external preform.

The present invention finds application in all fields where a container for the containing of liquids require adequate barrier protections, as a double-walled container can provide to the latter and in order to preserve all the physical properties of the contained product over time.

### STATE OF THE ART

As it is known, the containers obtained by blowing preforms in PET or similar material are intended to contain liquids for a number of product sectors: beverage, chemical, pharmaceutical, food, etc.

For certain uses and applications, it is necessary to make blown containers in PET or similar material which containers have double walls. More precisely, the system of having two concentric preforms is used when it is necessary to improve and enhance some features that cannot be obtained using a single preform. The constructive solution of having a container provided of a double wall is particularly suitable for containers intended to contain liquids which require a suitable protection for preserving characteristic properties thereof and preserving such liquids from the contact with air or other environments that can alter the chemical composition of the liquid product.

For example, typical is the case of a traditional container which, when partially emptied, there is an increase in the head space with a relevant increasing of the amount of air as the product comes out of the container. One of these conditions occurs for beer kegs.

As a matter of facts, in traditional containers the beer is dispensed by blowing CO2. The head space as the beer is dispensed is enriched with CO2, altering the balance between the liquid phase and the gaseous phase of the beer contained in the keg.

When making a double-walled container, the blowing of two preforms made of PET or similar material is provided for the making thereof, and wherein a first preform is coaxially inserted inside the second.

According to this embodiment, it is possible to provide to the two individual preforms different mechanical features according to the final use of the container and the type of liquid it will contain inside thereof.

For example, it is possible to obtain a double walled container through the blowing process of two preforms, wherein the external preform will have the function of mechanically protecting the internal container, while the internal preform, which is the one intended to receive the liquid, will have all the features and treatments necessary to preserve the properties of the liquid contained therein (for example, O2 barrier, CO2 barrier, UV barrier, etc.).

This constructive solution has the disadvantage given by the fact that for the production process of a double preform it is provided that the inserting step of the internal preform into the external preform it is normally carried out upstream of the blowing line. This assembling operation it is performed by sending the two preforms separately to an expensive automation system which inserts said two preforms one into each other, and conveying them to the next blowing line for the making of the container.

Alternatively and according to a different production process as the one indicated above, the internal and the external preforms are assembled downstream of their production line. This alternative constructive solution has a main disadvantage which consists in the fact that the assembled double preform is welded through an expensive welding system so as to prevent the two preforms from slipping off during their handling.

The present invention aims to solve the aforementioned disadvantages by providing a double preform production process in which the assembly of said two preforms (internal and external) it is provided in a permanent, simple and effective manner.

Thanks to the technical solution of the present invention, the double-walled container is thus obtained by blowing an already assembled double preform which contains a first and a second preform, the latter coaxially inserted into the first in a locked manner.

Therefore, the object of the present invention is to provide two preforms with a geometry such as to allow a fixed and permanent assembly of one preform inside the other, and in such a manner as to ensure that during the necessary handling both for the transporting and the processing of such preforms until the blowing thereof, the stability of the assembly be not compromised.

### BRIEF DESCRIPTION OF THE INVENTION

The object of the present invention is a process for the production of a concentric double wall assembled preform which comprises a first internal preform coaxially inserted into a second external preform, and wherein the two concentric preforms are mechanically assembled in an irreversible manner so as to provide a single indivisible body.

According to the present invention, the two concentric preforms are irreversibly coupled and can be handled and processed as if they were a single preform.

According to the invention, the two preforms are individually produced with materials that can be homogeneous or inhomogeneous.

Another object of the present invention is also the assembled concentric double walled preform obtained by the above process.

Therefore, the present invention provides a process for the production of a double-walled preform, and an assembled double-walled preform so obtained substantially according to the appended claims.

### DETAILED DESCRIPTION OF THE INVENTION

A detailed description of three preferred embodiments of a double-walled preform and the relevant assembling process according to the present invention will now be given, by way of non-limiting example and with reference to the annexed figures, wherein:

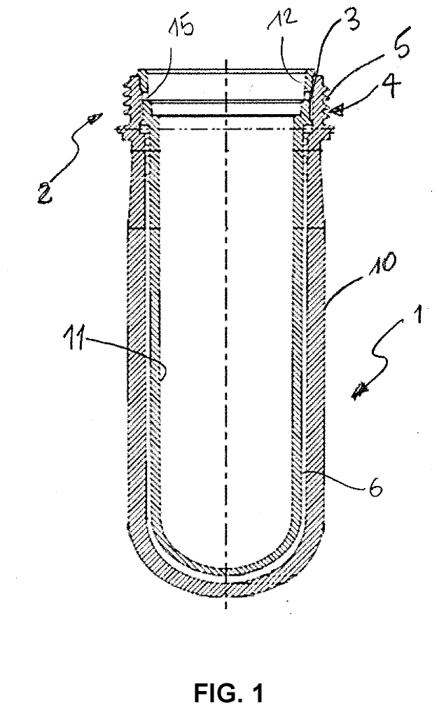

FIG. 1 shows a longitudinal sectional view of the first embodiment of the double-walled preform assembled according to the present invention;

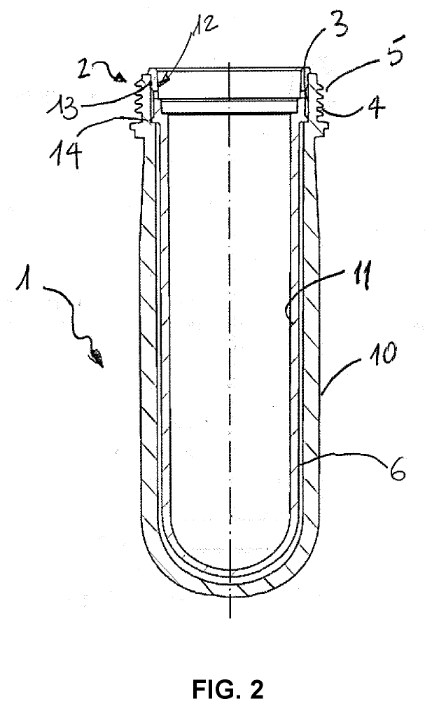

FIG. 2 is a second longitudinal sectional view of the assembled preform of FIG. 1 and according to the present invention;

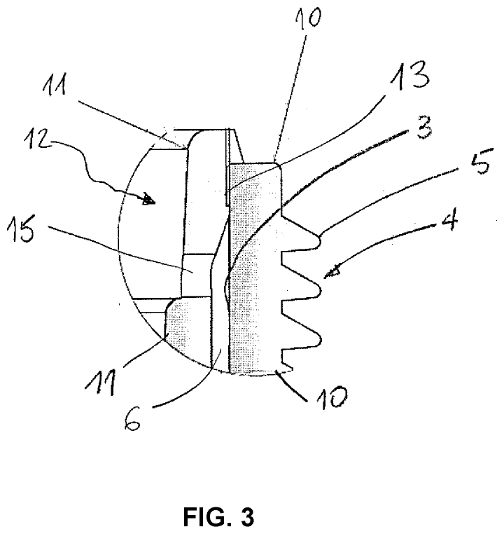

FIG. 3 is a partially sectional and detailed view of a part of the assembled preform of FIG. 1 and according to the present invention;

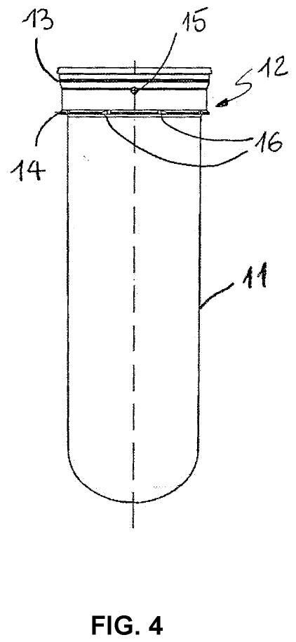

FIG. 4 is an elevational view of the internal preform which forms part of the assembled preform of FIG. 1 and according to the present invention;

FIG. 5 is an elevational and partial longitudinal section view of a second embodiment of the external preform according to the present invention;

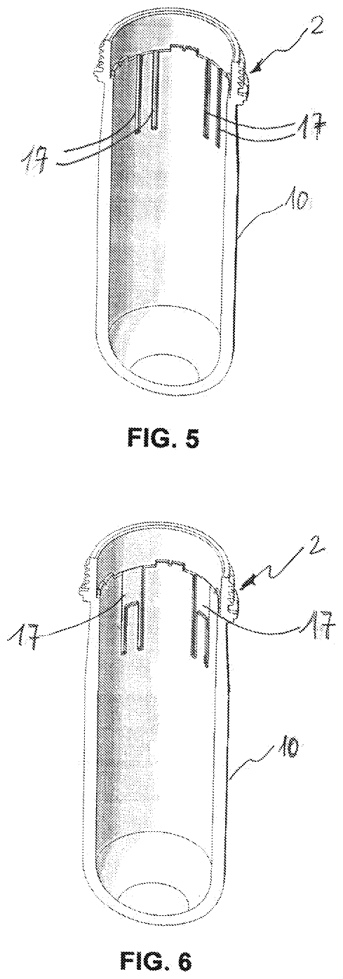

FIG. 6 is an elevational and partial longitudinal section view of a third embodiment of the external preform according to the present invention; and

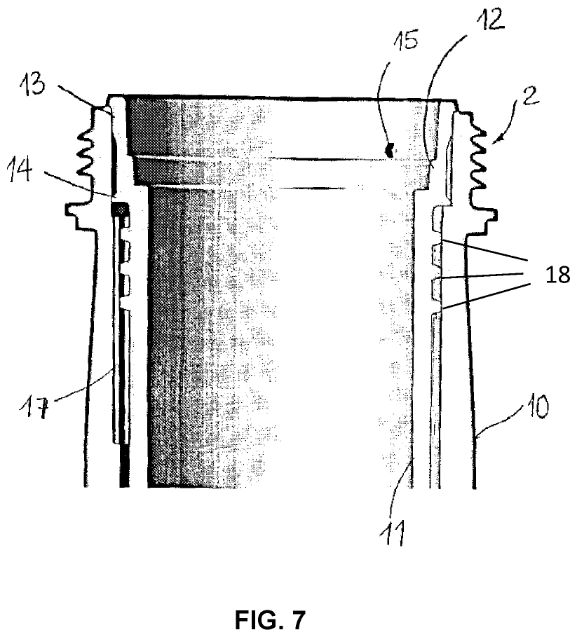

FIG. 7 is a partial longitudinal sectional view illustrating the assembled condition of the second embodiment of the external preform and the internal preforms.

With reference now to FIGS. 1 and 2, a first preferred embodiment of the assembled preform of the present invention is illustrated in longitudinal section.

According to the present invention, a preform 1 comprises a preform body 10 having a cylindrical profile, and a neck 2 which has a cylindrical internal profiled surface 3 and an external profiled surface 4 which comprises a thread 5 for the relevant coupling with a cap (not shown in the figures) in the manner already known.

Further, an internal preform 11 it is provided and which can be completely included/contained in the external preform 10 or surmount it for a short distance (as illustrated in the figures).

The internal preform 11 also has a neck 12 (and as for the external preform 10) having an internal profiled surface which is normally cylindrical or slightly frusto-conical, and not having contacting regions for the fixing of said preforms 10 and 11 one inside the other.

It should be pointed out here that according to the present invention the both external 10 and internal 11 preforms once assembled generate an interspace volume 6 between the external preform 10 and the internal preform 11, the volume 6 being able contain a volume of gas which is functional for the operation of the blown container (better illustrated below).

With particular reference now to FIG. 2, according to the present invention it is provided that the external profiled surface of the neck 12 of the internal preform 11 and the internal profiled surface 3 of the neck 2 of the external preform 10 are made in such a way as to each form one or more contacting regions 13 and 14 by interference, respectively, said contacting regions allowing the mutual locking of said two preforms 10 and 11 once assembled one inside the other and in a permanent manner. More precisely and as can be seen in the figure, once both preforms 10 and 11 are assembled one inside the other, the interference contacting regions 13 and 14 obtained on the respective neck profiled surfaces 3 and 12 are in a mutually locked contact by interference, thus obtaining the related locking of the internal preform 11 inside the external preform 10.

With reference now to FIG. 3, a part of the neck of the preform of FIG. 2 is therein illustrated in detail. As can be seen in the figure, the external profiled surface of the neck 12 of the internal preform 11 is made so as to create an interference region with the internal profiled surface 3 of the external preform 10 at the region 13.

Further, the neck region 12 of the internal preform 11 comprises at least one or more holes 15 (only one of which is illustrated in the figure), the holes 15 being adapted to communicate the internal volume 6 with the environment at the neck region 12 of the internal preform 11.

With reference now to FIG. 4, the internal preform 11 is shown in a front elevational view.

As can be seen in the figure, according to the present embodiment of the preform of the present invention, the outer surface of the neck part 12 of the inner preform 11 has two annular shaped contacting regions 13 and 14 which protrude from the surface of the former and are adapted to cooperate by interference with the respective neck regions of the internal profiled surface 3 of the external preform 10 when the first is mounted inside the second.

According to the present embodiment, a typical coupling interference value at the contacting regions 13 and 14 between the two preforms 10 and 11 it is preferably selected in the range of 0.1 mm but can be included in the range from 0.02 mm up to 0.5 mm depending on the applications of the double-walled container obtained after blowing the so assembled preform.

Further, as can be seen in the figure, the annular contacting region 14 comprises a series of longitudinal grooves 16 integrally formed in the contacting region 14 and arranged around the entire perimeter of the contacting region 14, the grooves 16 are suitable for communicating the internal volume 6 with the holes 15 and therefore allowing the gas contained in the volume 6 to flow from/towards the internal volume 6 through the holes 15 at the neck region 12 of the internal preform from/to the outside.

With reference now to FIG. 5, a second embodiment of the external preform 10 is illustrated therein.

For the sake of clarity, same parts will have the same numbers and their detailed description will be omitted here since already given above.

According to this second embodiment, the external preform 10 comprises a series of longitudinal grooves 17 formed along the internal wall of the preform 10 and up to the neck region. The function of these grooves 17 is to create an area where the gas contained in the volume 6 can more easily flow out and between the external preform 10 and the internal preform 11 through the grooves 16, and via the holes 15 towards the outside, for example during operation of the blown container (more precisely, both during the filling, the emptying, and during the recycling of the container).

The facilitated passage of the gas through the aforementioned grooves 17 and through the holes 15 allows to ensure that no overpressures are built up inside the container during the emptying of the latter, and in such a way as not to compromise the safety of the operators.

With reference now to FIG. 6, a third embodiment of the external preform 10 is shown.

For the sake of clarity, same parts will have the same numbers and their detailed description will be here omitted as already given above.

According to this third embodiment, the vertical grooves 17 have a wider shape and greater size than the grooves according to the second embodiment, and in such a way as to be distributed over a greater surface of the inner wall of the outer preform 10.

With reference now to FIG. 7, it illustrates the assembled condition of the external preform 10 together with the internal preform 11 according to the second or third embodiment and which incorporates the grooves 17. As can be seen in the figure, according to this embodiment, the outer neck surface region of the internal preform 11 has a series of further annular protruding regions 18 adapted to provide a stable contact at the region part immediately below the neck region of inner surface of the external preform 10 and below the contacting region 14.

As can be understood in the figure and according to this embodiment, the grooves 17 create a preferential region for the flowing of gas from/towards the internal volume 6 defined between preform 10 and preform 11 and through the grooves 16 and the holes 15 from/to the outside.

It should be noted here that following the blowing of the assembled preform, a blown container is obtained which comprises a substantially rigid external wall which is constituted by the material of the external preform 10, and a second container internally housed in the first which is substantially flexible and consists of the material of the internal preform 11. In this manner, an internal volume 6 is created between the two containers and which is variable according to the volume of liquid contained in the inner container 11.

Therefore, the grooves 17 together with the holes 15 in addition to cooperating for the operation of the blown container (so obtained following to the blowing of the two preforms 10 and 11) and by promoting the emptying of the liquid contained inside thereof, they consists in interstice spaces which promote a fast decompression of the blown container (keg) at the end of use thereof.

For the making of the assembled preform 1 the following production process is provided:

First, the external preform 10 and internal preform 11 are separately formed by an injection process into a mould and by injecting a material which is chosen according to the applications for which the double-walled container is intended to, and that will be obtained by blowing the aforementioned assembled preform 1 once paired.

Subsequently, the internal preform 11 is inserted inside the external preform 10 until the neck part 12 of the internal preform 11 rests on the neck part 3 of the external preform 10.

Then, the inner preform 11 is forcedly pushed inside the outer preform 10 by interference forcing the coupling at the contacting regions 13 and 14 at the profiled surfaces 12 and 3 of the respective neck regions of preforms 10 and 11 and as illustrated in FIGS. 2 and 3.

In this condition, the assembled preform 1 is irreversibly assembled and is ready to be delivered to the subsequent production steps to obtain a double-walled blown container, and according to a production process as it is already known in the state of the art.

The present invention has a number of advantages.

A first advantage is given by the fact that shipping costs are halved since two separate preforms are not transported any more but only one assembled preform comprising both preforms one inside the other.

A second advantage is given by the fact that the reduction of shipping costs allows a considerable enlargement of the markets and a considerable expansion of the fields of use of the concentric preforms.

A third advantage is given by the fact that the present double walled preform can be supplied directly into the blow moulding apparatus, eliminating the expensive automation system provided for the inserting the two preforms one into the other.

A fourth advantage is given by the fact that to any owner of a blow moulding apparatus can use the present preform without resorting to the automatic system which, in addition to being expensive, makes the whole system more complex by lowering its reliability.

1. Assembled preform (1) for the making of a blown container, comprising a first external preform body (10) which comprises a neck part (2) which has an external region (4) which includes a threaded region (5) and an internal surface region (3), and a second internal preform (11) which is suitable to be completely contained within said first external preform body (10), said second internal preform (11) having a neck region (12) suitable to cooperate with said neck internal surface (3) of said first external preform (10),
characterized in that said neck region (12) of said second internal preform (11) comprises locking means (13,14) integrally obtained on the material of said second preform (11) and suitable for cooperating by blocked interference with said internal surface region (3) of the neck part (2) of said external preform (10) when said second internal preform (11) is inserted in said first external preform (10).

2. Assembled preform (1) according to the preceding claim, wherein said locking means comprises two protruding annular contacting regions (13,14) integrally obtained on said neck region (12) of said second preform (11), said annular contacting regions (13,14) being adapted to cooperate by coupling interference with a respective inner surface (3) of the neck region of said outer preform (10) when the first is assembled inside the second.

3. Assembled preform (1) according to claim 1 or 2, wherein said coupling interference between said two preforms (10,11) has a value which is comprised in the range from 0.02 mm up to 0.5 mm according to the applications of said container.

4. Assembled preform (1) according to the preceding claim, wherein said coupling interference at said annular regions (13,14) between said two preforms (10,11) has a value comprised in the range of 0.1 mm.

5. Assembled preform (1) according to any of the preceding claims, wherein said external preform (10) and said internal preform (11) once assembled generate an interspace volume (6) between the external preform (10) and the internal preform (11), said volume (6) being able to receive and contain a determined gas.

6. Assembled preform (1) according to any of the preceding claims 2-5, wherein said annular region (14) of said internal preform (11) comprises a series of longitudinal grooves (16) formed along the entire perimeter of said annular region (14).

7. Assembled preform (1) according to the preceding claim, wherein the arrangement of said series of longitudinal grooves (16) is such that following the assembling of said second internal preform (11) inside said first external preform (10) said grooves (16) communicate the interspace volume (6) defined between said first preform (10) and said second preform (11) towards the outside of said neck region (12) of said second preform (11) through at least a pair of holes (15) on said neck region (12).

8. Assembled preform (1) according to any of the preceding claims, wherein said external preform (10) comprises a series of longitudinal vertical grooves (17) integrally obtained at the inner wall of a region close and underlying the neck region (2) of said preform (10), each of said grooves being arranged in the direction of the longitudinal axis of said preform (10).

9. Assembled preform (1) according to the preceding claim, wherein each of said vertical grooves (17) have an enlarged shape of greater size at the neck region (2) with respect to the size at the part underlying said neck region (2).

10. Assembled preform (1) according to claim 8 or 9, wherein following to the blowing of said assembled preform (1), a double walled blown container is obtained which comprises an first external wall which is substantially rigid and is constituted by the material of said external preform (10), and a second container internally arranged into said the first container which is substantially flexible and consists of the material of the internal preform (11), and an interspace internal volume (6) is defined between the two containers and being variable according to the volume of liquid contained in said internal container (11), and wherein the arrangement of said series of longitudinal grooves (17) at the internal wall of said external preform (10) is such that they create an area suitable for making the gas contained in said volume (6) to flow between said external preform (10) and said internal preform (11) and through said grooves (16) and said holes (15) from/to the outside.

11. Assembled preform (1) according to claim 8 or 9 or 10, wherein said internal preform (11) has a series of further protruding annular regions (18) arranged to provide a stable contact at an inner surface immediately below the neck region (2) of said external preform (10) and below said contacting region (14) when said internal preform (11) is housed inside the external preform (10).

12. Assembled preform (1) according to the preceding claim, wherein said grooves (17) are arranged to create a preferential passage for the flow of gas from/towards the inside of said interspace volume (6) defined between the external preform (10) and the internal preform (11) and through said grooves (16) and said holes (15) from/to the outside.

13. Process for the manufacturing of an assembled preform (1) comprising a first preform body (10) which comprises a neck part (2) which has an external surface region (4) which includes a threaded region (5) and an internal surface region(3), and a second internal preform (11) which arranged to be completely contained inside of said first preform body (10), said second internal preform (11) comprising a neck region (12) suitable for cooperating with said neck surface region (3) of said first preform (10), and wherein said neck region (12) of said second preform (11) comprises locking means (13,14) integrally obtained on the surface material of said second preform (11) and for cooperating with said internal surface region (3) of the neck part (2) of said external preform (10) by blocked interference coupling when said second internal preform (11) is inserted in said first external preform (10),
characterized in that it comprises the following steps:
Separate forming of said external preform (10) and said internal preform (11) by injection moulding;
Insertion of said internal preform (11) inside said external preform (10) until said neck part (12) of the internal preform (11) touches on the neck part (3) of the external preform (10);
Pushing the internal preform (11) inside the external preform (10) forcing by interference the coupling through said locking means (13,14) at the surfaces (12) and (3) of the respective neck regions of said preforms (10,11);
Obtaining an assembled preform (1) assembled in an irreversible arrangement; and
Delivering the said assembled preform (1) to the subsequent production steps to obtain a double-walled blown container.
